(19) United States
(12) Patent Application Publication
(10) Pub. No.: US 2018/0167874 A1
(43) Pub. Date: Jun. 14, 2018

(54) METHOD FOR INTELLIGENT EVENT DRIVEN PAGING USING A SECOND MOBILE UNIT

(71) Applicant: MOTOROLA SOLUTIONS, INC., CHICAGO, IL (US)

(72) Inventors: GABI OFIR, LETZION (IL); ETIAN KOREN, HERZELIYA (IL); ITZHAK SHPERLING, BNEI-BRAK (IL)

(21) Appl. No.: 15/375,282

(22) Filed: Dec. 12, 2016

(51) Int. Cl. H04W 52/02; H04W 48/18; H04W 8/20; H04W 36/00

(52) U.S. Cl. CPC H04W 52/02; H04W 48/18; H04W 88/06; H04W 36/0066; H04W 8/20

(57) ABSTRACT

A method is provided for waking up a first mode of a multimode mobile radio unit. An event driven paging server determines that the first mode of the multimode mobile unit should be woken up. A wakeup message is sent to a second mobile unit. The second mobile unit sends a wakeup message to a second mode of the multimode mobile unit using non-cellular technology, such as low-power short-range communication such as Bluetooth. The second mode of the multimode mobile radio unit receives the wakeup message and wakes up the first mode of the multimode mobile unit.

### BACKGROUND OF THE INVENTION

Mobile units rely on batteries to provide power for their operation. With ever-increasing functionality added to mobile units, the power consumption on batteries is increasing.

One way to save power is to periodically turn off functionality in an idle mobile unit by creating sleep mode periods which are interrupted periodically by short active waking state periods to send or receive messages or calls. By disabling functions, especially those that consume relatively large amounts of power, battery life can be extended. Unfortunately, the functionality that has been disabled, often referred to as put to sleep, cannot be used while in a sleep state.

One example of power saving comprises turning off a transceiver in a mobile unit while allowing other functionality to continue to operate. This sleep setting is effective in extending battery life, but makes the mobile unit unable to place or receive a call or other communication during the sleep mode periods.

In order to remediate the problem of having a mobile unit that cannot be contacted or place calls, mobile units can be programmed to wake up at periodic intervals and notify a base station that they are now active. Of course this consumes battery power, oftentimes for no useful purpose, if there are no notifications for the mobile unit. In addition, the timer rarely wakes up the mobile unit at the right time, since the wake up times are periodic. Still further, there is no way to contact the sleeping mobile unit. A dispatcher or other mobile unit must wait until the mobile unit wakes up, and even then messages may not get through or it may be too late for the user of the sleeping mobile unit to be of assistance.

Therefore a need exists for a method that allows a mobile unit to save battery while still allowing the mobile unit to be contacted by dispatchers or other mobile units and that does not require periodic wake up of the mobile unit.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a system diagram illustrating a network in accordance with an exemplary embodiment of the present invention.

FIG. 2 is a diagram illustrating a paging server in accordance with an exemplary embodiment of the present invention.

FIG. 3 depicts a flowchart of a method for waking up a first mode of a multimode mobile unit using a second mobile unit in accordance with an exemplary embodiment of the present invention.

FIG. 4 depicts a flowchart of a method for waking up a first mode of a multimode mobile unit in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Disclosed is an improved method for waking up a first mode of a multimode mobile radio unit using a second mobile unit in an event-driven way. A first mode of a multimode mobile unit is put to sleep, wherein the functionality of the first mode is disabled when put to sleep. The multimode mobile unit consumes much less battery power when the first mode is in sleep mode, up to approximately fifty percent less power. A second mode of the multimode mobile unit receives a wakeup message to wake up the first mode of the multimode mobile unit. The wake up message comes from a second mode communication system connecting to the second mode part of the multimode mobile radio. The trigger to wake up comes from the novel event driven Paging Server that has all information regarding the communication activities of the first communication mode system. The Paging Server sends the paging trigger when needed, based on pre-defined events. The first mode of the multimode mobile unit is woken up in response to the wakeup message.

In accordance with an exemplary embodiment of the present invention, the multimode mobile radio unit is connected to a second mobile radio unit by a short-range, low-energy communication method, such as Bluetooth. Usually the two collaborative mobile radio units are carried by the same user in close proximity to each other. The first mode of the multimode mobile radio unit is put to sleep. The second mobile radio unit receives a wakeup message for the first mode of the multimode mobile unit. The wakeup message is received through the second mode communication system to which the second mobile radio unit is connected. The trigger to wake up comes from the event-driven Paging Server that has information regarding the communication activities of the first communication mode system. The Paging Server sends the paging trigger when needed, based on pre-defined events and not periodically as in the current art.

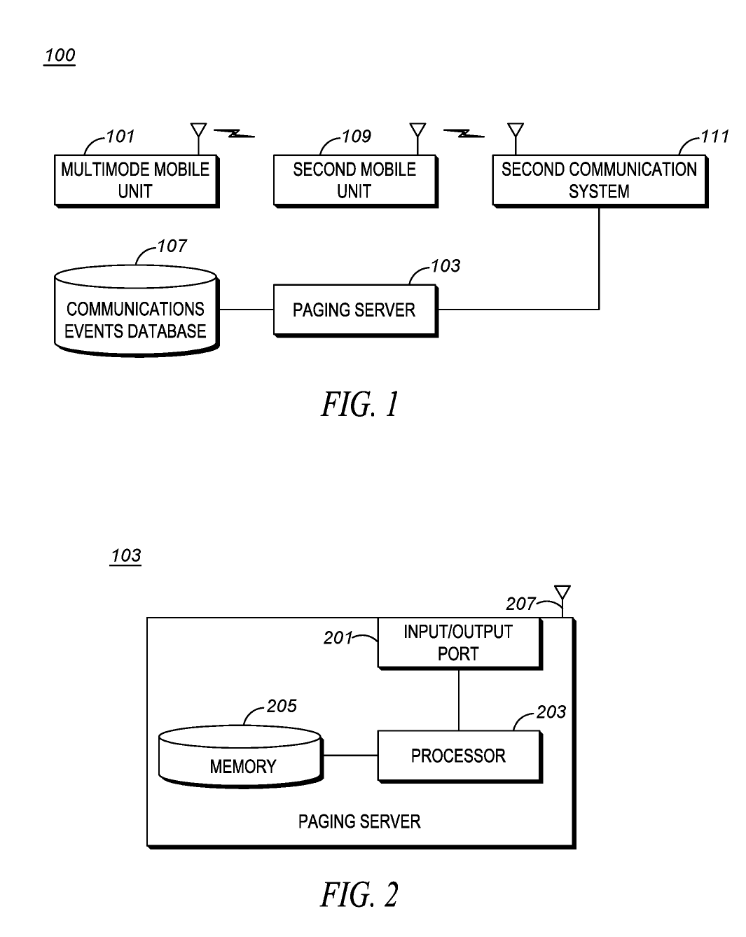

FIG. 1 is a system diagram illustrating a network 100 in accordance with an exemplary embodiment of the present invention. Network 100 includes Multimode Mobile Unit 101, Paging Server 103, Communications Events Database 107, Second Mobile Unit 109, and Second Communication System 111.

Multimode Mobile Unit 101 is a portable communication unit that can make and receive calls over a radio frequency carrier while the user is moving within a service area. A multi-mode mobile unit operates across different standards, and may operate on analog networks as well. Multimode Mobile Unit 101 includes a short-range low-energy communication port, such as Bluetooth or the like.

Paging Server 103 is a server that is used to page mobile units, such as Multimode Mobile Unit 101. Paging Server 103 is coupled to database 107 and Second Communication System 111. Paging Server 103 preferably resides on a dedicated computer. Paging Server 103 is described in greater detail in FIG. 2 below.

Database 107 is a storage device for storing information and data. Database 107 is coupled to Paging Server 103 and preferably stores information about Multimode Mobile Unit 101 and the user of Multimode Mobile Unit 101. In an exemplary embodiment, Database 107 stores a group that the multimode mobile unit belongs to, such as a public safety agency. In a further exemplary embodiment, Database 107 stores a list of high priority events that can lead to the first mode of Multimode Mobile Unit 101 being woken up, such as public safety events. In a further exemplary embodiment, Database 107 stores attributes of Multimode Mobile Unit 101 or a user of Multimode Mobile Unit 101, such as the role of the user, the job level of the user, or an expertise that the user has.

Second Mobile Unit 109 is a portable communication unit that can make and receive calls, similar to Multimode Mobile Unit 101. Second Mobile Unit 109 is coupled to Second Communication System 111 and includes wireless technology to communicate with base stations and also wireless technology to communicate with other mobile units, such as Multimode Mobile Unit 101, via Bluetooth or Wi-Fi.

Second Communication System 111 is preferably a cellular communication system that provides communication ability between users and other communication units, whether they are located on Second Communication System 111 or a different communication system.

FIG. 2 is a diagram illustrating paging server 103 in accordance with an exemplary embodiment of the present invention. Paging Server 103 preferably includes an input/output port 201, a processor 203, memory 205, and a transceiver 207.

Input/output port 201 is an interface to other computing devices, such as Database 107. Input/output port 201 can utilize any suitable connector or protocol that is effective in transmitting and receiving signals from other computing devices.

Processor 203 is a microprocessor that is effective in receiving inputs from input/output port 201 and making calculations based on these inputs. In an exemplary embodiment, processor 203 determines that a first mode of multimode mobile unit 101 should be woken up in response to an event, rather than at a predetermined, periodic time. The event can be a local sensor measurement, user input, monitoring of a control channel for a message intended for the first mode of the multimode mobile unit. In a further exemplary embodiment, the event can be the geographic location of multimode mobile unit 101, such as the entering or exiting of a geo-fence area or a predetermined location of multimode mobile unit 101, such as a cell edge, and in particular a cell edge with RF link uncertainty. Processor 203 can also determine that a first mode of multimode mobile unit 101 should be woken up based upon a group that multimode mobile unit 101 belongs to. For example, the group can be a public safety agency, such as a police or fire department.

Memory 205 preferably stores information relating to system 100, multimode mobile unit 101, and second mobile unit 109.

Transceiver 207 communicates over the air with multimode mobile unit 101 and second mobile unit 109.

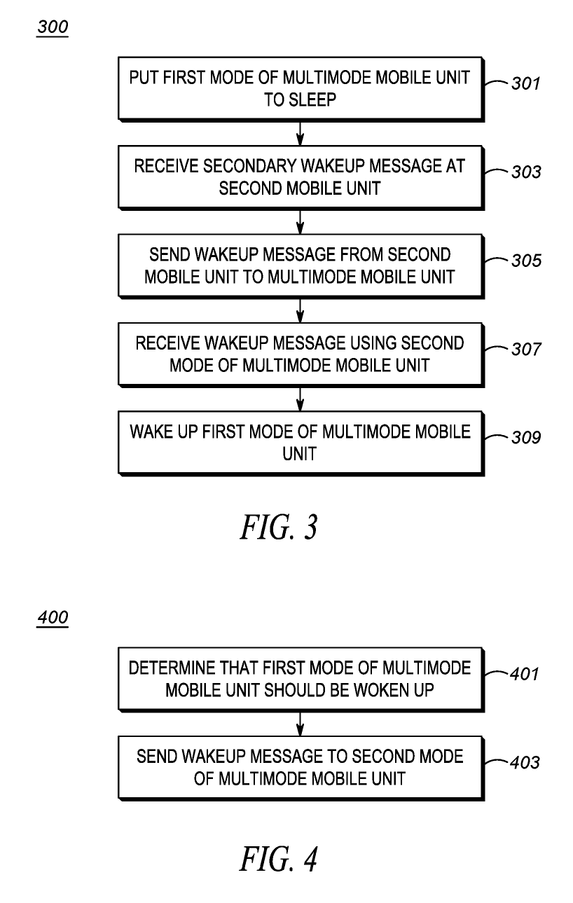

FIG. 3 depicts a flowchart 300 of a method for waking up a first mode of a multimode mobile unit using a second mobile unit in accordance with an exemplary embodiment of the present invention. In this exemplary embodiment, a paging server sends a wakeup message to a second mobile unit, which in turn sends a wakeup message to the multimode mobile unit using a second mode. This can be done, for example, to save battery resources of multimode mobile unit 101. In this exemplary embodiment, multimode mobile unit 101 can be woken up in a non-periodic way, as opposed to being woken up at predetermined set time intervals.

A first mode of multimode mobile unit is put (301) to sleep. As used herein, the term “put to sleep” or the like refers to a state in which functionality of a mode is disabled and therefore the mode utilizes fewer resources when in the sleep state.

Second mobile unit 109 receives (303) a secondary wakeup message. The secondary wakeup message preferably comprises a request to wake up the first mode of multimode mobile unit 101. This message can be received at any time that multimode mobile unit 101 is asleep, and is not a periodic message sent only at predetermined times. In this way, multimode mobile unit 101 does not need to wake up at certain intervals, but can stay asleep until certain events or triggers occur.

Second mobile unit 109 sends (305) a wakeup message to a second mode of multimode mobile unit 101. The wakeup message is preferably a message to wake up the first mode of multimode mobile unit 101. In a first exemplary embodiment, the wakeup message is sent utilizing Bluetooth technology. In a further exemplary embodiment, the wakeup message is sent utilizing Wi-Fi technology.

The second mode of multimode mobile unit 101 receives (307) the wakeup message.

The first mode of multimode mobile unit 101 is woken up (309) in response to the wakeup message.

FIG. 4 depicts a flowchart 400 of a method for waking up a first mode of a multimode mobile unit in accordance with an exemplary embodiment of the present invention.

Paging Server 103 determines (401) that a first mode of multimode mobile unit 101 should be woken up. In a first exemplary embodiment, the step of determining that the first mode of multimode mobile unit 101 should be woken up comprises determining that a first mode should be woken up in response to an event. In this embodiment, the first mode of multimode mobile unit 101 is asleep, for example to extend the battery life of a battery within multimode mobile unit 101.

The event can be, as one example, a local sensor measurement. In this exemplary embodiment, a sensor may take a reading that indicates the need for a specific person or skill set, such as a firefighter if a temperature sensor exceeds a predetermined value.

In a further exemplary embodiment, the event may be a user input. In this exemplary embodiment, dispatcher 105 may want to communicate with mobile unit 101, but may be aware that the user of multimode mobile unit 101 is currently off-duty. The first mode of multimode mobile unit 101 may therefore be sleeping, while a second mode of multimode mobile unit 101 may be awake and able to receive messages. In this scenario, user input can define the event that triggers the waking of the first mode of multimode mobile unit 101.

In a further exemplary embodiment, the event is a cloud-based wake-up message.

In a further exemplary embodiment, the event comprises the geographic location of multimode mobile unit 101. In one example, the geographic location of multimode mobile unit 101 comprises the entering of a geo-fence area. In this example, the first mode of multimode mobile unit 101 is woken up when entering a geo-fence area so that others may communicate with the first mode while in the geo-fence area.

The geographic location of multimode mobile unit 101 can also comprise the exiting of a geo-fence area. In this exemplary embodiment, the first mode of multimode mobile unit 101 is woken up when leaving a geo-fence area so that others may communicate with the first mode after leaving the geo-fence area. This can be beneficial after a user obtains necessary equipment within the geo-fence area and now leaves the geo-fence area and is ready to provide services.

The geographic location of multimode mobile unit 101 can also comprise a predetermined location. For example, a dispatcher can wake up the first mode of multimode mobile unit 101 when multimode mobile unit 101 is located near an incident, such as a crime scene or a building fire.

A further example of a predetermined location is a cell edge, in particular a cell edge with RF link uncertainty. In this scenario, the first mode of multimode mobile unit 101 is asleep while multimode mobile unit 101 moves toward a cell edge with RF link uncertainty. If the first mode of multimode mobile unit 101 stayed asleep and entered a “bad” cell, proper handoff of multimode mobile unit 101 could be inhibited. In this scenario, waking up the first mode of multimode mobile unit 101 as it approaches a cell edge with RF link uncertainty can be advantageous.

In a further exemplary embodiment, the step of determining that the first mode of multimode mobile unit 101 should be woken up comprises determining that the first mode of multimode mobile unit 101 should be woken up based upon a group that multimode mobile unit 101 belongs to. For example, if the first mode of multimode mobile unit 101 is asleep and multimode mobile unit 101 belongs to a public safety group or agency, the first mode of multimode mobile unit 101 can be woken up if there is an emergency or other situation that requires public safety assistance. For example, if there are riots, natural disasters, or other incidents that need public safety assistance, multimode mobile unit 101 may be awoken so that the user of multimode mobile unit 101 can assist in responding to the incident. Individual members of the public safety group can be wakened, or all members of the public safety group can be wakened. depending on the scope and severity of the incident.

In a further exemplary embodiment, the step of determining that the first mode of multimode mobile unit 101 should be woken up comprises determining that a first mode of a multimode mobile unit should be woken up based upon the identity of the calling party. For example, if the calling party is a dispatcher, this may signal that a communication with the first mode of multimode mobile unit 101 is important and therefore the first mode of multimode mobile unit 101 should be woken up. Similarly, if the calling party is a member of list of preapproved numbers, the first mode of multimode mobile unit 101 is woken up. This can be helpful in emergency cases when a supervisor needs to contact a worker, especially if the worker is a public safety employee. This can also be useful if a user wants to conserve the battery of a multimode mobile unit but still wants to be contacted by certain people, such as a spouse or children of the user.

In a further exemplary embodiment, the step of determining that the first mode of multimode mobile unit 101 should be woken up comprises determining that the first mode of multimode mobile unit 101 should be woken up based upon the location of the caller. For example, a user of multimode mobile unit 101 may want to conserve the battery of multimode mobile unit 101, but may want to be contacted whenever someone calls from predetermined locations, such as the police station or an area around his or her residence.

In a further exemplary embodiment, the step of determining that the first mode of multimode mobile unit 101 should be woken up comprises determining that a first mode of multimode mobile unit 101 should be woken up based upon a location update message.

In a further exemplary embodiment, the step of determining that the first mode of multimode mobile unit 101 should be woken up comprises determining that a first mode of multimode mobile unit 101 should be woken up based upon a high priority event, such as a public safety event.

In a further exemplary embodiment, the step of determining that the first mode of multimode mobile unit 101 should be woken up comprises determining that multimode mobile unit 101 belongs to a user with a predetermined role. Alternately, the step of determining that the first mode of multimode mobile unit 101 should be woken up comprises determining that multimode mobile unit 101 belongs to a user with a predetermined job level or expertise.

Paging Server 103 sends (403) a wakeup message to a second mode of multimode mobile unit 101. The wakeup message preferably instructs the second mode of multimode mobile unit 101 to wake up the first mode of multimode mobile unit 101.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for waking up a multimode mobile unit, the method comprising:
determining that a first mode of a multimode mobile unit should be woken up, the first mode being operable on a cellular network;
receiving a wakeup message at a second mobile unit; and
sending a non-cellular wakeup message from the second mobile unit to a second mode of the multimode mobile unit, the non-cellular wakeup message instructing the second mode to wake up the first mode.

2. The method of claim 1, wherein the step of sending a non-cellular wakeup message comprises sending a non-cellular wakeup message utilizing Bluetooth technology.

3. The method of claim 1, wherein the step of sending a non-cellular wakeup message comprises sending a non-cellular wakeup message utilizing a Wi-Fi connection.

4. The method of claim 1, wherein the step of determining that a first mode of a multimode mobile unit should be woken up comprises determining that a first mode of a multimode mobile unit should be woken up in response to an event.

5. The method of claim 4, wherein the event comprises a local sensor measurement.

6. The method of claim 4, wherein the event comprises the geographic location of the multimode mobile unit.

7. The method of claim 6, wherein the geographic location of the multimode mobile unit comprises entering of a geo-fence area.

8. The method of claim 6, wherein the geographic location of the multimode mobile unit comprises exiting of a geo-fence area.

9. The method of claim 6, wherein the geographic location of the multimode mobile unit comprises a predetermined location.

10. The method of claim 9, wherein the predetermined location comprises a cell edge with RF link uncertainty.

11. The method of claim 4, wherein the event is a public safety event.

12. The method of claim 1, wherein the step of determining that a first mode of a multimode mobile unit should be woken up comprises determining that a first mode of a multimode mobile unit should be woken up based upon a group that the multimode mobile unit belongs to.

13. The method of claim 12, wherein the group comprises a public safety agency.

14. The method of claim 1, wherein the step of determining that a first mode of a multimode mobile unit should be woken up comprises determining that a first mode of a multimode mobile unit should be woken up based upon the identity of the calling party.

15. The method of claim 1, wherein the step of determining that a first mode of a multimode mobile unit should be woken up comprises determining that a first mode of a multimode mobile unit should be woken up based upon the location of the caller.

16. The method of claim 1, wherein the step of determining that a first mode of a multimode mobile unit should be woken up comprises determining that the multimode mobile unit belongs to a user with a predetermined expertise.
